(19) United States
(12) Patent Application Publication
(10) Pub. No.: US 2025/0047608 A1
(43) Pub. Date: Feb. 6, 2025

(54) MULTI-HOP TRANSMISSION METHOD AND COMMUNICATION APPARATUS

(71) Applicant: HUAWEI TECHNOLOGIES CO., LTD., Shenzhen (CN)

(72) Inventors: Zhongfeng LI, Shanghai (CN); Zhang ZHANG, Shanghai (CN); Qi FENG, Shanghai (CN)

(21) Appl. No.: 18/919,686

(22) Filed: Oct. 18, 2024

Related U.S. Application Data
(63) Continuation of application No. PCT/CN2023/088720, filed on Apr. 17, 2023.

(30) Foreign Application Priority Data
Apr. 21, 2022 (CN) 202210422400.6

(51) Int. Cl. H04L 47/17; H04L 5/00; H04W 28/02

(52) U.S. Cl. CPC H04L 47/17; H04L 5/0048; H04W 28/0268

(57) ABSTRACT

The technology of this application is directed to reducing a data transmission latency in multi-hop transmission and improving data transmission efficiency, A method is provided and may be applied to a multi-hop transmission system. The method includes a first node obtaining second transmission parameter information. The second transmission parameter information may include one or more of the following: quality of service (QoS) configuration information, candidate transmission path information, candidate transmission resource information, or a candidate forwarding mode. The first node determines first transmission parameter information based on the second transmission parameter information. The first node sends service data to a second node based on the first transmission parameter information, where the second node is a next-hop node determined by the first node based on the first transmission parameter information.

### CROSS-REFERENCE TO RELATED APPLICATIONS

This application is a continuation of International Application No. PCT/CN2023/088720, filed on Apr. 17, 2023, which claims priority to Chinese Patent Application No. 202210422400.6, filed on Apr. 21, 2022. The disclosures of the aforementioned applications are hereby incorporated by reference in their entireties.

### TECHNICAL FIELD

This disclosure relates to the communication field, and in particular, to a multi-hop transmission method and a communication apparatus.

### BACKGROUND

As a frequency supporting wireless communication increases, to increase a communication coverage area, data transmission may be performed in a relay manner. A relay system includes three types of nodes: a network device, a relay device, and a terminal device. The relay device may also be referred to as a relay node, and is located between the network device and the terminal device. To implement wider coverage, dual-hop or more-hop relay transmission is usually used for forming a multi-hop relay system.

Currently, relays defined by the 3rd Generation Partnership Project (3GPP) in integrated access and backhaul (IAB) and sidelink transmission are regenerative relays, at least layer 2 (L2) data forwarding processing is performed at the relays, and processing time is long. Consequently, a data transmission latency is long. In addition, the sidelink does not support multi-hop transmission. When multi-hop transmission is performed in an IAB system, each relay node needs to independently perform current-hop scheduling, and scheduling time is long. This also causes a long data transmission latency.

### SUMMARY

This disclosure provides a multi-hop transmission method and a communication apparatus, to reduce a data transmission latency in multi-hop transmission and improve data transmission efficiency.

To achieve the foregoing objective, this disclosure uses the following technical solutions.

According to a first aspect, a multi-hop transmission method is provided. The method includes: A first node obtains second transmission parameter information, where the second transmission parameter information may include one or more of the following: quality of service (QoS) configuration information, candidate transmission path information, candidate transmission resource information, and a candidate forwarding mode; the first node determines first transmission parameter information based on the second transmission parameter information; and the first node sends service data to a second node based on the first transmission parameter information, where the second node is a next-hop node determined by the first node based on the first transmission parameter information.

Based on the multi-hop transmission method provided in the first aspect, the first node may obtain, by obtaining the second transmission parameter information that meets a requirement of QoS from the first node to a destination end, a candidate transmission parameter set that is of each node in a current multi-hop transmission network and that is centrally configured, and the first node may determine, from the second transmission parameter information, scheduling information used by the first node to forward the service data, namely, the first transmission parameter information. In this way, the first node determines the first transmission parameter information based on the second transmission parameter information, so that a parameter selection range of the first node can be reduced, and signaling overheads can be reduced. In this way, time for the first node to configure the transmission parameter information of a current hop is reduced, and a data transmission latency is reduced. Alternatively, the first node may obtain, from the second transmission parameter information, an optimal transmission parameter through matching for data transmission. This further reduces the data transmission latency, and further improves data transmission efficiency during multi-hop transmission.

In some embodiments, that the first node determines first transmission parameter information based on the second transmission parameter information includes: The first node obtains one or more pieces of link status information of the first node and one or more next-hop nodes. The link status information may include one or more of the following: channel quality information, a transmission rate, a transmission latency, and service load information. The first node may determine the first transmission parameter information based on the one or more pieces of link status information and the second transmission parameter information. In this way, the first node may obtain, in real time, link status information between the first node and a next-hop node that can perform service data transmission, the first transmission parameter information determined from the second transmission parameter information based on the link status information can better adapt to an instantaneous channel status, a real-time scheduling gain of the current hop is obtained, and dynamic scheduling of the multi-hop transmission is implemented, so that reliability and efficiency of the multi-hop transmission can be improved.

In some embodiments, the first transmission parameter information may include one or more of the following: transmission path information, transmission resource information, and a forwarding mode. In this way, the first node may determine the second node (namely, the next-hop node) based on the transmission path information, and then send the service data, the second transmission parameter information, and the like to the second node based on the determined transmission resource information and forwarding mode, so that low-latency multi-hop transmission is implemented.

In some embodiments, the forwarding mode may include one or more of the following: layer 0 forwarding, layer 1 forwarding, and layer 2 forwarding. In this way, the forwarding mode determined by the first node may be any one or a combination of the foregoing three forwarding modes, and is applicable to different service and scenario requirements. For example, based on the configured resource information, the first node may use some resources for L2 forwarding, and/or some resources for L1 forwarding, and/or some resources for L0 forwarding.

In some embodiments, the method according to the first aspect further includes: The first node sends the second transmission parameter information and/or the first transmission parameter information to the second node. In this way, the first node may send the second transmission parameter information and/or the first transmission parameter information to the second node based on the determined first transmission parameter information, so that the second node can quickly configure the transmission parameter information based on the second transmission parameter information, to improve the data transmission efficiency.

In some embodiments, the second transmission parameter information and/or the first transmission parameter information may be carried in lower layer signaling. In this way, transmission of the second transmission parameter information and/or the first transmission parameter information based on the lower layer signaling can reduce data processing time and improve data forwarding efficiency. The second transmission parameter information and the first transmission parameter information may be carried in same lower layer signaling for sending, or may be carried in different lower layer signaling for separate sending. The lower layer signaling may be L1/physical layer (PHY) signaling.

In some embodiments, that the first node sends the second transmission parameter information and/or the first transmission parameter information to the second node includes: After the first node sends the second transmission parameter information to the second node, the first node sends the first transmission parameter information to the second node. In this way, the first node may send the second transmission parameter information to the second node in advance, so that the second node configures the transmission parameter information in advance. This can further improve the data transmission rate. The first transmission parameter information may be sent together with the service data.

In some embodiments, the second transmission parameter information may be carried in higher layer signaling. In this way, the second transmission parameter information and the first transmission parameter information are separately sent, and the second transmission parameter information may be carried in the higher layer signaling for sending, for example, media access control (MAC) control element (CE) signaling and radio resource control (RRC) signaling, where the higher layer signaling may be activated by using the L1 (which may also be referred to as layer 1 or physical layer) signaling, to better control effective time of the signaling.

According to a second aspect, a multi-hop transmission method is provided. The method includes: A second node sends link status information between a first node and the second node to the first node, where the link status information includes one or more of the following: channel quality information, a transmission rate, a transmission latency, and service load information, and the link status information is used by the first node to determine first transmission parameter information; and the second node receives second transmission parameter information and/or the first transmission parameter information from the first node, where the second transmission parameter information includes one or more of the following: quality of service (QoS) configuration information, candidate transmission path information, candidate transmission resource information, and a candidate forwarding mode, the first transmission parameter information indicates the first node to send service data, and the first node is a previous-hop node of the second node.

In some embodiments, the second transmission parameter information and/or the first transmission parameter information are/is carried in lower layer signaling.

In some embodiments, that the second node receives second transmission parameter information and/or the first transmission parameter information from the first node includes: After the second node receives the second transmission parameter information from the first node, the second node receives the first transmission parameter information from the first node.

In some embodiments, the second transmission parameter information is carried in higher layer signaling.

In some embodiments, the first transmission parameter information may include one or more of the following: transmission path information, transmission resource information, and a forwarding mode.

In some embodiments, the forwarding mode includes one or more of the following: layer 0 forwarding, layer 1 forwarding, and layer 2 forwarding.

In addition, for technical effects of the multi-hop transmission method according to the second aspect, refer to technical effects of the multi-hop transmission method according to the first aspect.

According to a third aspect, a communication apparatus is provided. The apparatus may be deployed on a first node. The apparatus includes a processing module and a transceiver module. The processing module is configured to obtain second transmission parameter information, where the second transmission parameter information includes one or more of the following: quality of service (QoS) configuration information, candidate transmission path information, candidate transmission resource information, and a candidate forwarding mode. The processing module is further configured to determine first transmission parameter information based on the second transmission parameter information. The transceiver module is configured to send service data to a second node based on the first transmission parameter information, where the second node is a next-hop node determined by the apparatus based on the first transmission parameter information.

In some embodiments, the processing module is configured to perform the following step: obtaining one or more pieces of link status information of the first node and one or more next-hop nodes, where the link status information includes one or more of the following: channel quality information, a transmission rate, a transmission latency, and service load information; and determining the first transmission parameter information based on the one or more pieces of link status information and the second transmission parameter information.

In some embodiments, the first transmission parameter information includes one or more of the following: transmission path information, transmission resource information, and a forwarding mode.

In some embodiments, the forwarding mode includes one or more of the following: layer 0 forwarding, layer 1 forwarding, and layer 2 forwarding.

In some embodiments, the transceiver module is further configured to send the second transmission parameter information and/or the first transmission parameter information to the second node.

In some embodiments, the second transmission parameter information and/or the first transmission parameter information are/is carried in lower layer signaling.

In some embodiments, the transceiver module is configured to: after sending the second transmission parameter information to the second node, send the first transmission parameter information to the second node.

In some embodiments, the second transmission parameter information is carried in higher layer signaling.

In some embodiments, the transceiver module may include a receiving module and a sending module. The sending module is configured to implement a sending function of the communication apparatus according to the third aspect, and the receiving module is configured to implement a receiving function of the communication apparatus according to the third aspect.

In some embodiments, the communication apparatus according to the third aspect may further include a storage module. The storage module stores a program or instructions. When the processing module executes the program or the instructions, the communication apparatus according to the third aspect may be enabled to perform the method according to the first aspect.

In some embodiments, the communication apparatus according to the third aspect may be a terminal device, a network device, or a relay device, or may be a chip (system) or another part or component that may be disposed in the terminal device, the network device, or the relay device, or may be an apparatus that includes the terminal device, the network device, or the relay device

According to a fourth aspect, a communication apparatus is provided. The apparatus may be deployed on a second node. The apparatus includes a transceiver module. The transceiver module is configured to send link status information between a first node and the second node to the first node, where the link status information includes one or more of the following: channel quality information, a transmission rate, a transmission latency, and service load information, and the link status information is used by the first node to determine first transmission parameter information. The transceiver module is further configured to receive second transmission parameter information and/or the first transmission parameter information from the first node, where the second transmission parameter information includes one or more of the following: quality of service (QoS) configuration information, candidate transmission path information, candidate transmission resource information, and a candidate forwarding mode, the first transmission parameter information indicates the first node to send service data, and the first node is a previous-hop node of the second node.

In some embodiments, the second transmission parameter information and/or the first transmission parameter information are/is carried in lower layer signaling.

In some embodiments, the transceiver module is configured to: after receiving the second transmission parameter information from the first node, receive the first transmission parameter information from the first node.

In some embodiments, the second transmission parameter information is carried in higher layer signaling.

In some embodiments, the first transmission parameter information includes one or more of the following: transmission path information, transmission resource information, and a forwarding mode.

In some embodiments, the forwarding mode includes one or more of the following: layer 0 forwarding, layer 1 forwarding, and layer 2 forwarding.

In some embodiments, the transceiver module may include a receiving module and a sending module. The sending module is configured to implement a sending function of the communication apparatus according to the third aspect, and the receiving module is configured to implement a receiving function of the communication apparatus according to the third aspect.

In some embodiments, the communication apparatus according to the fourth aspect may further include a processing module. The processing module is configured to implement a processing function of the communication apparatus according to the fourth aspect.

In some embodiments, the communication apparatus according to the fourth aspect may further include a storage module. The storage module stores a program or instructions. When the processing module executes the program or the instructions, the communication apparatus according to the fourth aspect may be enabled to perform the method according to the second aspect.

In some embodiments, the communication apparatus according to the fourth aspect may be a terminal device, a network device, or a relay device, or may be a chip (system) or another part or component that may be disposed in the terminal device, the network device, or the relay device, or may be an apparatus that includes the terminal device, the network device, or the relay device.

According to a fifth aspect, a communication apparatus is provided. The communication apparatus includes a processor and a memory. The memory is configured to store computer instructions. When the processor executes the instructions, the communication apparatus is enabled to perform the method according to any one of the first aspect and the second aspect.

In some embodiments, the communication apparatus according to the fifth aspect may further include a transceiver. The transceiver may be used by the communication apparatus according to the fifth aspect to communicate with another communication apparatus.

In this disclosure, the communication apparatus according to the fifth aspect may be the first node or the second node in the first aspect, or a chip (system) or another part or component that may be disposed on the first node or the second node, or an apparatus that includes the first node or the second node.

According to a sixth aspect, a communication apparatus is provided. The communication apparatus includes an input/output interface and a logic circuit. The input/output interface is configured to input and/or output information. The logic circuit is configured to: perform the method according to any one of the first aspect or the embodiments of the first aspect, or perform the method according to any one of the second aspect or the embodiments of the second aspect.

In addition, for technical effects of the communication apparatuses according to the third aspect to the sixth aspect, refer to technical effects of the method according to the first aspect.

According to a seventh aspect, a communication system is provided. The communication system includes one or more terminal devices, one or more network devices, and one or more relay devices.

According to an eighth aspect, a computer-readable storage medium is provided, including a computer program or instructions. When the computer program or the instructions are run on a computer, the computer is enabled to perform the method according to any one of the first aspect and the second aspect.

According to a ninth aspect, a computer program product is provided, including a computer program or instructions. When the computer program or the instructions are run on a computer, the computer is enabled to perform the method according to any one of the first aspect and the second aspect.

According to a tenth aspect, an embodiment of this disclosure provides a computer program. When the computer program is run on a computer, the method according to any one of the first aspect or the embodiments of the first aspect is performed, or the method according to any one of the second aspect or the embodiments of the second aspect is performed.

### BRIEF DESCRIPTION OF DRAWINGS

FIG. 1A is a diagram 1 of an architecture of a communication system according to an example embodiment of this disclosure;

FIG. 1B is a diagram 2 of an architecture of a communication system according to an example embodiment of this disclosure;

FIG. 2 is a diagram 3 of an architecture of a communication system according to an example embodiment of this disclosure;

FIG. 3 is a diagram of an architecture of a control plane protocol stack of a relay device according to an example embodiment of this disclosure;

FIG. 4 is a diagram of an architecture of a data plane protocol stack of a relay device according to an example embodiment of this disclosure;

FIG. 5 is a diagram of a structure of L1 forwarding performed by a relay device according to an example embodiment of this disclosure;

FIG. 6 is a diagram of a structure of L0 forwarding performed by a relay device according to an example embodiment of this disclosure;

FIG. 7 is a schematic flowchart of a multi-hop transmission method according to an example embodiment of this disclosure;

FIG. 8 is a diagram 1 of a structure of a multi-hop multi-link network according to an example embodiment of this disclosure;

FIG. 9 is a diagram 2 of a structure of a multi-hop multi-link network according to an example embodiment of this disclosure;

FIG. 10 is a diagram of a structure of implementing multi-hop transmission through centralized+distributed scheduling according to an example embodiment of this disclosure;

FIG. 11 is a diagram of a structure of implementing multi-hop transmission through centralized scheduling according to an example embodiment of this disclosure;

FIG. 12 is a diagram of a structure of data processing performed by a relay node during full-duplex and half-duplex communication according to an example embodiment of this disclosure;

FIG. 13 is a diagram 1 of a structure of a communication apparatus according to an example embodiment of this disclosure; and

FIG. 14 is a diagram 2 of a structure of a communication apparatus according to an example embodiment of this disclosure.

### DESCRIPTION OF EMBODIMENTS

The following describes technical solutions of this disclosure with reference to accompanying drawings.

The technical solutions in embodiments of this disclosure may be applied to various communication systems, for example, an internet of vehicles communication system, an uncrewed aerial vehicle communication system, a wireless backhaul communication system, a machine to machine (M2M) communication system, a 4th generation (4G) mobile communication system like a long term evolution (LTE) system, a worldwide interoperability for microwave access (WiMAX) communication system, a 5th generation (5G) mobile communication system like a new radio (NR) system, and a future communication system like a 6th generation (6G) mobile communication system.

For example, embodiments of this disclosure may be applied to various communication scenarios. For example, embodiments of this disclosure may be applied to a communication scenario in which a high-frequency spectrum is used, for example, millimeter wave, terahertz, and optical communication, or may be applied to a communication scenario in which there is both an extended coverage requirement and a latency constraint requirement.

All aspects, embodiments, or features are presented in this disclosure by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of this disclosure, terms such as “example” and “for example” are used to represent giving an example, an illustration, or a description. Any embodiment or implementation scheme described as an “example” in this disclosure should not be explained as being more preferred or having more advantages than another embodiment or implementation scheme. Exactly, the term “example” is used to present a concept in a specific manner.

In embodiments of this disclosure, terms “information”, “signal”, “message”, “channel”, and “signaling” may sometimes be interchangeably used. It should be noted that meanings expressed by the terms are consistent when differences of the terms are not emphasized. Terms “of”, “relevant”, and “corresponding” may sometimes be interchangeably used. It should be noted that meanings expressed by the terms are consistent when differences of the terms are not emphasized.

In embodiments of this disclosure, a subscript, for example, W₁, may sometimes be written incorrectly in a non-subscript form, for example, W1. Meanings expressed by the forms are consistent when differences of the forms are not emphasized.

A network architecture and a service scenario described in embodiments of this disclosure are intended to describe the technical solutions in embodiments of this disclosure more clearly, and do not constitute a limitation on the technical solutions provided in embodiments of this disclosure. A person of ordinary skill in the art may know that: With evolution of the network architecture and emergence of new service scenarios, the technical solutions provided in embodiments of this disclosure are also applicable to similar technical problems.

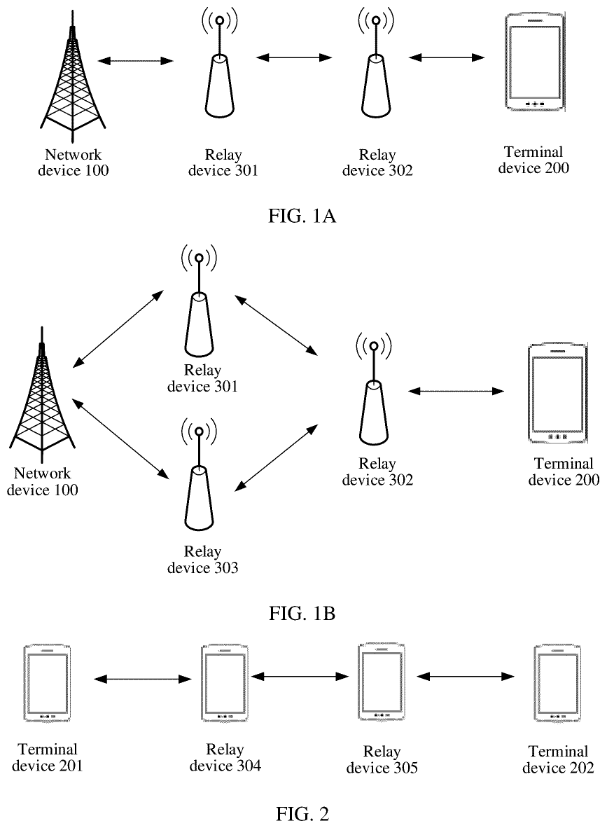

For ease of understanding embodiments of this disclosure, a communication system shown in FIG. 1A is first used as an example to describe in detail a communication system applicable to embodiments of this disclosure. For example, FIG. 1A is a diagram 1 of an architecture of a communication system according to an embodiment of this disclosure.

The communication system includes a network device 100, a terminal device 200, and at least two relay devices that are located between the network device 100 and the terminal device 200, for example, a relay device 301 and a relay device 302. A plurality of relay devices may be configured to forward a radio frequency signal between the network device 100 and the terminal device 200 for a plurality of times.

Specifically, during downlink transmission, the relay device 301 and the relay device 302 forward, for a plurality of times, a radio frequency signal transmitted by the network device 100, and transmit the radio frequency signal to the terminal device 200. In other words, the radio frequency signal arrives at the terminal device 200 through a plurality of hops. During uplink transmission, the relay device 301 and the relay device 302 forward, for a plurality of times, a radio frequency signal transmitted by the terminal device 200, and transmit the radio frequency signal to the network device 100. In other words, the radio frequency signal arrives at the network device 100 through a plurality of hops.

It should be noted that the communication system shown in FIG. 1A is a three-hop relay system. In a direction from the network device 100 to the terminal device 200, in this embodiment of this disclosure, a hop from the network device 100 to the relay device 301 may be defined as a first hop, a hop from the relay device 301 to the relay device 302 may be defined as a second hop, and a hop from the relay device 302 to the terminal device 200 may be defined as a third hop, so that the network device 100 is a first-hop device, the relay device 301 is a second-hop device, and the relay device 302 is a third-hop device. Conversely, it may also be defined in a direction from the terminal device 200 to the network device.

The network device 100 is a device that is located on a network side of the communication system and that has a wireless transceiver function, or a chip or a chip system that can be disposed in the device. The network device includes but is not limited to: an access point (AP), for example, a home gateway, a router, a server, a switch, or a bridge, in a wireless fidelity (Wi-Fi) system, an evolved NodeB (eNB), a radio network controller (RNC), a NodeB (NB), a base station controller (BSC), a base transceiver station (BTS), a home base station (for example, a home evolved NodeB, a home NodeB, HNB), a baseband unit (BBU), a wireless relay node, a wireless backhaul node, a transmission reception point (TRP), transmission point (TP), or the like. The network device may alternatively be a gNB or a TRP or a TP in a 5G system, for example, an NR system, or one antenna panel or a group of antenna panels (including a plurality of antenna panels) of a base station in a 5G system. The network device may alternatively be a network node, for example, a baseband unit (BBU) or a distributed unit (DU), that constitutes a gNB or a transmission point, a road side unit (RSU) having a base station function, or the like.

The terminal device 200 is a terminal that accesses the communication system and that has a wireless transceiver function, or a chip or a chip system that can be disposed in the terminal. The terminal device may also be referred to as a user apparatus, an access terminal, a subscriber unit, a subscriber station, a mobile station, a remote station, a remote terminal, a mobile device, a user terminal, a terminal, a wireless communication device, a user agent or a user apparatus. The terminal device in embodiments of this disclosure may be a mobile phone, a tablet computer (e.g. a Pad), a computer with a wireless transceiver function, a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in transportation safety, a wireless terminal in a smart city, a wireless terminal in a smart home, an in-vehicle terminal, an RSU with a terminal function, or the like. The terminal device in this disclosure may alternatively be a vehicle-mounted module, a vehicle-mounted module assembly, a vehicle-mounted component, a vehicle-mounted chip, or a vehicle-mounted unit that is built in a vehicle as one or more components or units. The vehicle may use the vehicle-mounted module, the vehicle-mounted module assembly, the vehicle-mounted component, the vehicle-mounted chip, or the vehicle-mounted unit that is built in the vehicle, to implement the method provided in this disclosure.

The relay device may also be referred to as a relay node. The relay device 301 and/or the relay device 302 may be distributed at a cell edge, so that coverage of the network device 100 can be expanded. The relay device 301 or the relay device 302 may communicate with the terminal device, or may communicate with the network device. The relay device may be a relay base station, for example, a micro base station, or may be a relay terminal, for example, an idle terminal, or may be a network entity like a relay transmission point, customer premise equipment (CPE), a relay transceiver, or a relay agent.

In addition, FIG. 1B is a diagram 2 of an architecture of a communication system according to an embodiment of this disclosure. In comparison with the communication system shown in FIG. 1A, the communication system shown in FIG. 1B further includes a relay device 303. The network device 100, the relay device 301, the relay device 302, and the terminal device 200 form a multi-hop link. The network device 100, the relay device 303, the relay device 302, and the terminal device 200 form a multi-hop link. Therefore, the network device 100 may communicate with the terminal device 200 through of the multi-hop links, and the communication system is a multi-hop multi-link communication system. Specifically, the communication system shown in FIG. 1B is a 3-hop 2-link communication system.

FIG. 1A and FIG. 1B show multi-hop transmission between the network device and the terminal device. The plurality of relay devices between the network device and the terminal device may be terminal devices, network devices, or a combination of a terminal device and a network device. The multi-hop transmission method provided in embodiments of this disclosure is further applicable to multi-hop transmission between terminal devices.

For example, FIG. 2 is a diagram 3 of an architecture of a communication system according to an embodiment of this disclosure. As shown in FIG. 2, the communication system includes a terminal device 201 and a terminal device 202, and a relay device 304 and a relay device 305 that are located between the terminal device 201 and the terminal device 202. The relay device 304 and the relay device 305 are terminal devices. In this case, the relay device 304 and the relay device 305 may also be referred to as relay terminals, and are configured to forward, for a plurality of times, a radio frequency signal between the terminal device 201 and the terminal device 202.

Specifically, the terminal devices may communicate with each other. For example, the terminal device 201 may communicate with the relay device 304 through a sidelink, or the relay device 304 may communicate with the relay device 305 through a sidelink.

In some embodiments, the relay device 304 and the relay device 305 may be replaced with network devices. In this case, the relay device may be referred to as a relay base station, or any one of the relay device 304 and the relay device 305 is replaced with a network device. In other words, the relay device may be a combination of a relay terminal and a relay base station.

Both the communication system shown in FIG. 2 and the communication system shown in FIG. 1A are multi-hop single-link relay systems. Similarly, the communication system shown in FIG. 2 may also form a multi-hop multi-link relay system. Refer to the system architecture shown in FIG. 1B.

It may be understood that the multi-hop relay system forms a multi-hop transmission network, and the multi-hop relay system may include a network device, or may include a terminal device, or may include a network device and a terminal device. The communication systems shown in FIG. 1A, FIG. 1B, and FIG. 2 all belong to a multi-hop transmission network. During multi-hop transmission, a device that initiates data transmission may be referred to as a source node. For example, the source node may be the network device 100 in FIG. 1A or FIG. 1B, or may be the terminal device 201 in FIG. 2. A device for forwarding data may be referred to as a relay node or an intermediate node, for example, the relay device 301 and the relay device 302 in FIG. 1A or FIG. 1B, or the relay device 304 and the relay device 305 in FIG. 2. A device for receiving data may be referred to as a destination node. For example, the destination node may be the terminal device 200 in FIG. 1A or FIG. 1B, or may be the terminal device 202 in FIG. 2. The foregoing source node and destination node may be defined based on a data transmission direction. It should be noted that the source node may also be referred to as an information source node, and the destination node may also be referred to as a sink node.

It should be noted that, the solutions in embodiments of this disclosure may alternatively be applied to another communication system, and a corresponding name may alternatively be replaced with a name of a corresponding function in the another communication system.

It should be understood that FIG. 1A, FIG. 1B, and FIG. 2 are merely simplified diagrams of examples for ease of understanding. The communication system may further include another network device, and/or another relay device, and/or another terminal device, not shown in FIG. 1A, FIG. 1B, and FIG. 2.

Currently, relays defined by the 3GPP in IAB and sidelink transmission are regenerative relays. In a data transmission process, at least layer 2 (L2) data forwarding processing is performed at the relays, and processing time is long. Consequently, a data transmission latency is long.

In addition, when multi-hop transmission is performed in an IAB system, for example, the communication system shown in FIG. 1A or FIG. 1B, each relay node needs to independently perform current-hop scheduling, and scheduling time is long. This also causes a long data transmission latency. In addition, the sidelink does not support the multi-hop transmission, and supports a centralized scheduling mode of a base station and autonomous distributed scheduling of user equipment. In addition, L0 relay forwarding is used for a smart repeater being discussed in R18, and the smart repeater can accept centralized scheduling of a network node and focus on a dual-hop system. However, a dedicated network relay device needs to be deployed, and the deployment faces challenges and flexibility is poor. In addition, the relay device has problems of noise and interference amplification.

Therefore, to reduce the data transmission latency in the multi-hop transmission, an embodiment of this disclosure provides a multi-hop transmission method, to implement low-latency data transmission on a common node instead of a dedicated node.

First, for ease of understanding the solutions provided in embodiments of this disclosure, the following provides an architecture of a protocol stack of a relay device provided in embodiments of this disclosure.

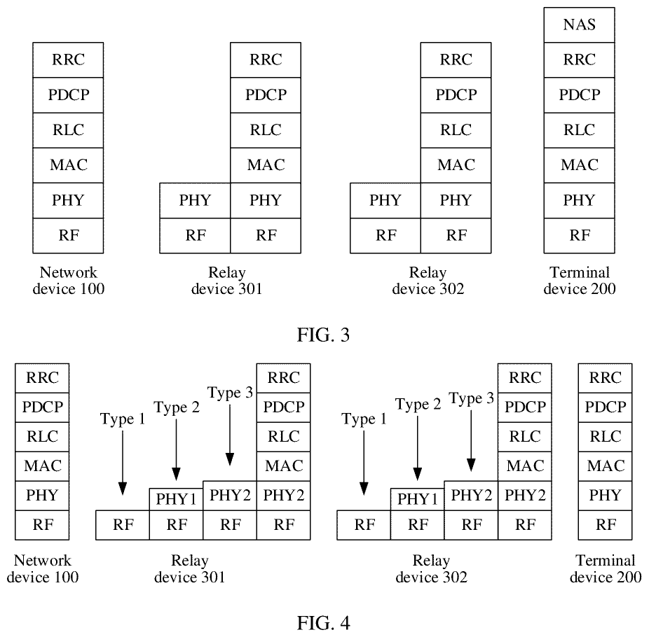

As shown in FIG. 3, an embodiment of this disclosure provides a diagram of an architecture of a control plane protocol stack of a relay device. The control plane protocol stack may be applied to the communication systems shown in FIG. 1A, FIG. 1B, and FIG. 2. In FIG. 3, the communication architecture shown in FIG. 1A is used as an example to describe the control plane protocol stack of the relay device. To be specific, there are two relay devices (for example, the relay device 301 and the relay device 302) between the network device 100 and the terminal device 200.

As shown in FIG. 3, the protocol stack of the network device 100 and/or the terminal device 200 may include a radio resource control (RRC) layer, a packet data convergence protocol (PDCP) layer, a radio link control (RLC) layer, a media access control (MAC) layer, a physical layer (PHY), and a radio frequency (RF) layer. In addition, the terminal device 200 may further include a non-access stratum (NAS) layer. The relay device 301 includes a protocol stack equivalent to the network device 100 and a protocol stack equivalent to the relay device 302. The protocol stack equivalent to the network device 100 may include a PHY layer and an RF layer from top to bottom, and the protocol stack equivalent to the relay device 302 may include an RRC layer, a PDCP layer, an RLC layer, a MAC layer, a PHY layer, and an RF layer from top to bottom. For the protocol stack of the relay device 302, refer to the relay device 301 and FIG. 3.

Optionally, the protocol stack equivalent to the network device 100 in the relay device 301 and/or a protocol stack equivalent to the relay device 301 in the relay device 302 may further include an RRC layer, a PDCP layer, an RLC layer, and a MAC layer.

It may be understood that the protocol stack may be divided into L0, L1, L2, and L3, where the RF layer belongs to L0, the PHY layer belongs to L1, the PDCP layer, the RLC layer, and the MAC layer belong to L2, and the RRC layer belongs to L3.

It should be noted that L1 forwarding is mainly used for a control plane of the relay device 301 or the relay device 302 provided in this embodiment of this disclosure, so that a forwarding latency can be reduced and a data transmission rate can be increased. Therefore, FIG. 3 shows only a part of a protocol stack structure.

Further, an embodiment of this disclosure further provides a diagram of an architecture of a data plane protocol stack of a relay device. The architecture of the data plane protocol stack of the relay device may also be applied to the communication systems shown in FIG. 1A, FIG. 1B, and FIG. 2. As shown in FIG. 4, the communication architecture shown in FIG. 1A is also used as an example to describe the data plane protocol stack of the relay device. To be specific, there are two relay devices (for example, the relay device 301 and the relay device 302) between the network device 100 and the terminal device 200.

Data plane protocol stack structures of the network device 100 and the terminal device 200 in FIG. 4 are similar to control plane protocol stack structures of the network device 100 and the terminal device 200 in FIG. 3. For details, refer to FIG. 4. A protocol stack equivalent to the network device 100 in the relay device 301 or a protocol stack equivalent to the relay device 301 in the relay device 302 has the following three types:

Type 1: An RF layer is included, and the RF layer performs L0 forwarding processing on data, for example, amplifies and forwards (AF) data from the network device 100.

Type 2: An RF layer and a PHY1 layer are included, and the RF layer and the PHY1 layer perform L1 forwarding processing on data, for example, perform soft forwarding (SF) or demodulation and forwarding (DMF) on data from the network device 100.

Type 3: An RF layer and a PHY2 layer are included, and the RF layer and the PHY2 layer perform L1 forwarding processing on data, for example, decode and forward (DF) data from the network device 100.

It may be understood that the PHY1 layer and the PHY2 layer are obtained through division based on different data processing functions. For example, the PHY1 layer can implement a demodulation or soft demodulation function, and the PHY2 layer can implement a decoding function.

It should be noted that the relay device may also include L2 protocol layer forwarding processing. Because in this embodiment of this disclosure, to implement low-latency forwarding processing, the relay device uses low-latency L0/L1 forwarding for forwarding, and in comparison with a fixed forwarding mode used by the relay device, for example, the relay device supports only the L0 forwarding or only the L1 forwarding. The relay device provided in this embodiment of this disclosure may support forwarding processing at a flexible protocol layer, and may adapt to different service and scenario requirements.

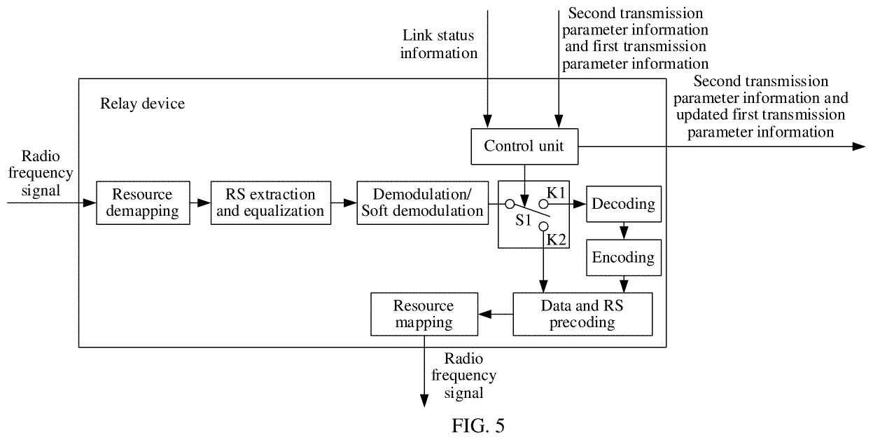

FIG. 5 is a diagram of a structure of L1 forwarding performed by a relay device according to an embodiment of this disclosure. The relay device may be any relay device in FIG. 1A, FIG. 1B, or FIG. 2, and the relay device has the architectures of the protocol stacks shown in FIG. 3 and FIG. 4.

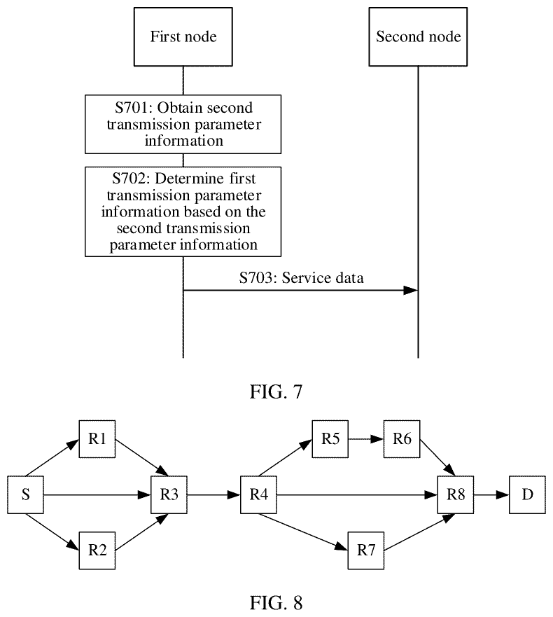

As shown in FIG. 5, the relay device includes a control unit, and the control unit is configured to control a mode of forwarding service data. The relay device receives second transmission parameter information and first transmission parameter information from a previous-hop device, obtains link status information between the relay device and a next-hop device, and updates the first transmission parameter information based on the link status information and the second transmission parameter information; and the control unit of the relay device controls the L1 forwarding mode based on updated first transmission parameter information, performs L1 forwarding processing on the received service data, and sends the second transmission parameter information and the updated first transmission parameter information to the next-hop device. The previous-hop device may be the network device or the relay device shown in FIG. 1A or FIG. 1B, or may be the terminal device or the relay device shown in FIG. 2. For specific content of the second transmission parameter information and the first transmission parameter information, refer to the following method embodiment shown in FIG. 7.

It may be understood that the received first transmission parameter information includes parameter information used by the previous-hop device for transmission of the service data, and the updated first transmission parameter information includes parameter information used by the current relay device for transmission of the service data.

For example, the relay device may be the relay device 301 shown in FIG. 1A. The relay device 301 receives a radio frequency signal from a source node (for example, the network device 100), and the radio frequency signal carries service data to be sent to a sink node (for example, the terminal device 200). It may be understood that the radio frequency signal may be sent to the relay device 301 through a radio channel after the network device 100 performs processing such as channel coding, modulation, data and reference signal (RS) precoding, and resource mapping on the service data.

The relay device 301 receives the second transmission parameter information and the first transmission parameter information from the network device 100. Both the second transmission parameter information and the first transmission parameter information are determined by the network device 100. The second transmission parameter information includes a candidate parameter set used by each device in the communication system shown in FIG. 1A for service data transmission, and the first transmission parameter information includes the parameter information that is determined by the network device and that is used for transmission of the service data.

In addition, the relay device 301 may further obtain link status information between the relay device 301 and the relay device 302, so that the control unit of the relay device 301 may update the first transmission parameter information based on the link status information and the second transmission parameter information, and control the L1 forwarding mode of the service data based on the updated first transmission parameter information. It may be understood that the updated first transmission parameter information may include the parameter information that is determined by the relay device 301 and that is used for transmission of the service data.

For example, if the L1 forwarding mode determined in the updated first transmission parameter information is DF, the control unit controls a switch S1 to connect to K1. In this case, the relay device 301 needs to perform resource demapping, RS extraction and equalization, demodulation or soft demodulation, and decoding processing on the received radio frequency signal, and then perform data encoding, data and RS precoding, and resource mapping, to forward the service data to the relay device 302 in a form of a radio frequency signal through a channel.

For another example, if the L1 forwarding mode determined in the updated first transmission parameter information is SF or DMF, the control unit controls a switch S1 to connect to K2. In this case, the relay device 301 needs to perform resource demapping, RS extraction and equalization, and demodulation or soft demodulation processing on the received radio frequency signal, and then perform data and RS precoding and resource mapping, to forward the service data to the relay device 302 in a form of a radio frequency signal through a channel. It can be learned that, in comparison with the DF, in the SF or the DMF, decoding processing does not need to be performed on the service data, so that a data processing procedure is reduced, and data forwarding efficiency is improved.

In addition, the control unit of the relay device 301 may further send the second transmission parameter information and the updated first transmission parameter information to the relay device 302. For an L1 forwarding procedure of the relay device 302, refer to the L1 forwarding procedure of the relay device 301.

It should be noted that a pilot may be introduced in the L1 forwarding process of the relay device, and is for channel estimation and beam interference management, so that interference and noise can be suppressed.

In addition, an embodiment of this disclosure further provides a diagram of a structure of L0 forwarding performed by a relay device. Alternatively, the relay device may be any relay device in FIG. 1A, FIG. 1B, or FIG. 2, and the relay device has the architectures of the protocol stacks shown in FIG. 3 and FIG. 4.

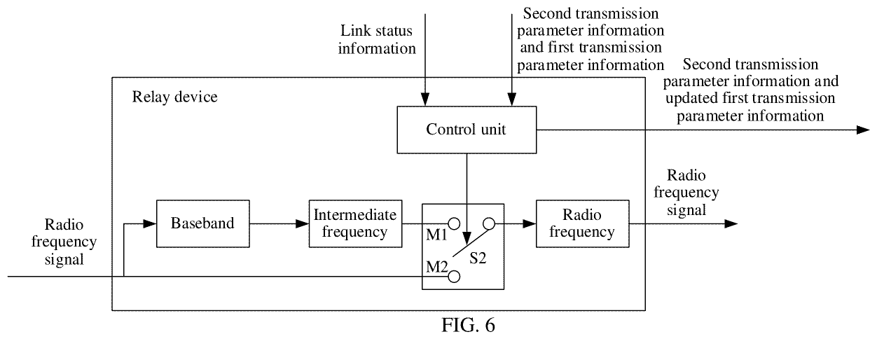

As shown in FIG. 6, a relay device receives second transmission parameter information and first transmission parameter information from a previous-hop device, obtains link status information between the relay device and a next-hop device, and updates the first transmission parameter information based on the link status information and the second transmission parameter information; and a control unit of the relay device performs L0 forwarding processing on received service data based on the updated first transmission parameter information, and sends the second transmission parameter information and the updated first transmission parameter information to the next-hop device.

For example, the relay device is the relay device 301 shown in FIG. 1A or FIG. 1B. At a moment t1, the control unit of the relay device controls a switch S2 to connect to M1. In this case, the relay device 301 is in an L1 or L2 forwarding mode. In other words, baseband, intermediate frequency, and radio frequency processing need to be performed on a received radio frequency signal, and then the radio frequency signal is sent. However, if the forwarding mode in the first transmission parameter information updated by the control unit of the relay device 301 at the moment t1 is AF, the control unit of the relay device controls the switch S2 to connect to M2, and determines that L0 amplification and forwarding processing is performed on the service data at a moment t2. In other words, the baseband and the intermediate frequency processing do not need to be performed on the received radio frequency signal, and radio frequency amplification and forwarding are directly performed on the radio frequency signal.

It should be noted that the baseband, intermediate frequency, and radio frequency processing shown in FIG. 6 may include processes such as the encoding and modulation shown in FIG. 5. For details, refer to related descriptions in a conventional technology.

The communication system and the relay device provided in embodiments of this disclosure are described above. For ease of understanding the technical solutions in embodiments of this disclosure, embodiments of this disclosure provide a multi-hop transmission method, to reduce a data transmission latency in multi-hop transmission. The following describes in detail the multi-hop transmission method provided in embodiments of this disclosure with reference to FIG. 7 to FIG. 12.

For example, FIG. 7 is a schematic flowchart of a multi-hop transmission method according to an embodiment of this disclosure. The multi-hop transmission method is applicable to the communication system shown in FIG. 1A, FIG. 1B, or FIG. 2, and may be performed by the network device, the relay device, or the terminal device shown in FIG. 1A, FIG. 1B, or FIG. 2, to implement multi-hop transmission with a low latency and improve a data transmission rate.

As shown in FIG. 7, the multi-hop transmission method includes the following steps.

S701: A first node obtains second transmission parameter information.

The second transmission parameter information may include one or more of the following: quality of service (QoS) configuration information, candidate path information, candidate resource information, or a candidate forwarding mode. The second transmission parameter information may be obtained through centralized configuration by a source node, and the second transmission parameter information includes a candidate transmission parameter set used by a node of each hop in a multi-hop network for service data transmission. The candidate transmission parameter set may include a candidate path set, a candidate beam set, a candidate control resource set, and the like. For details, refer to the following descriptions.

In some embodiments, the first node may be the source node.

For example, an embodiment of this disclosure provides a diagram 1 of a structure of a multi-hop multi-link network. The multi-hop multi-link network may be selected from an established multi-hop network topology, and each node in the multi-hop multi-link network may perform multi-hop transmission scheduling. As shown in FIG. 8, in the multi-hop multi-link transmission network, a source node S sends service data to a destination node D via a plurality of relay nodes. S represents the source node, D represents the destination node, R1 to R8 represent the relay nodes, and the source node S may be the network device 100 shown in FIG. 1A or FIG. 1B, or may be the terminal device 201 shown in FIG. 2. The destination node D may be the terminal device 200 shown in FIG. 1A or FIG. 1B, or may be the terminal device 202 shown in FIG. 2. The relay nodes R1 to R8 may be the relay devices shown in FIG. 1A, FIG. 1B, or FIG. 2.

Specifically, the source node S may consider an end-to-end QoS requirement, and collect statistics on information reported by the relay nodes (R1 to R8) of hops between the source node S and the destination node D, that is, statistics information of each hop, for example, channel state information (CSI), service status information (such as load and a periodicity), resource occupation information, and beam quality information reported by the relay node of each hop. The second transmission parameter information is centrally configured based on the statistics information of each hop.

The QoS configuration information may include an end-to-end latency requirement, reliability requirement, minimum data rate requirement, service periodicity of a periodic service, and the like. The QoS configuration information can ensure that after multi-hop transmission, end-to-end performance can meet the requirement. In addition, the QoS configuration information may be used for priority comparison between the service data forwarded by the relay node and local service data on which resource multiplexing is performed. For example, when a priority of the forwarded service data is higher than that of the local service data, resources are preferentially used for the forwarded service data.

The candidate path information may include a source node identifier (ID), a destination node ID, a candidate path ID, a path node ID corresponding to a candidate path, and the like; or the candidate path information may include a source node ID, a destination node ID, a candidate primary path ID, a path node ID corresponding to a candidate primary path, a candidate sub-path ID, a path node ID corresponding to a candidate sub-path, and the like. Specifically, the source node may determine the candidate path information in the following two manners.

Manner 1-1: The source node determines all candidate paths from the source node to the destination node based on the statistics information of each hop, and allocates a node ID to a corresponding path node on each candidate path, where each candidate path corresponds to one candidate path ID.

As shown in FIG. 8, there are nine paths from the source node S to the destination node D, and corresponding candidate path IDs may be 1 to 9, for example, a candidate path 1 {S, R1, R3, R4, R5, R6, R8, D}, a candidate path 2 {S, R3, R4, R5, R6, R8, D}, a candidate path 3 {S, R2, R3, R4, R5, R6, R8, D}, a candidate path 4 {S, R1, R3, R4, R8, D}, a candidate path 5 {S, R3, R4, R8, D}, a candidate path 6 {S, R2, R3, R4, R8, D}, a candidate path 7 {S, R1, R3, R4, R7, R8, D}, a candidate path 8 {S, R3, R4, R7, R8, D}, and a candidate path 9 {S, R2, R3, R4, R7, R8. D}. In this case, the candidate path information may include a source node ID, a destination node ID, the nine candidate path IDs, and a path node ID corresponding to each candidate path.

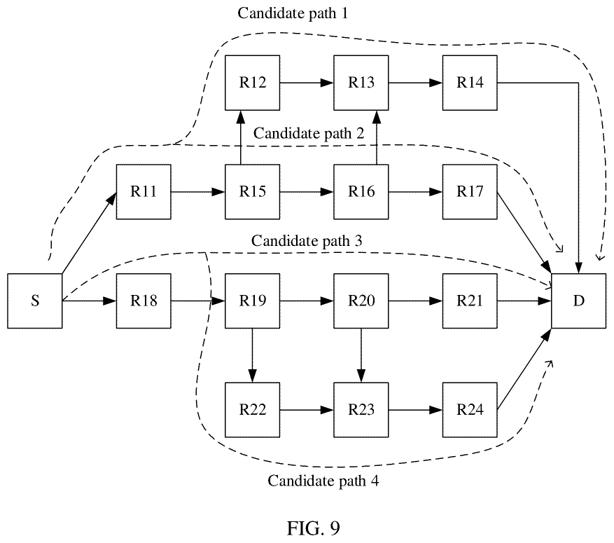

For another example, FIG. 9 is a diagram 2 of a structure of a multi-hop multi-link network. S represents a source node, D represents a destination node, and R11 to R24 represent relay nodes. As shown in FIG. 9, four candidate paths are determined between the source node S and the destination node D based on statistics information (such as the channel state information) of each hop, and correspondingly are a candidate path 1 {S, R11, R12, R13, R14, D}, a candidate path 2 {S, R11, R15, R16, R17, D}, a candidate path 3 {S, R18, R19, R20, R21, D}, and a candidate path 4 {S, R18, R19, R22, R23, R24, D}. In this case, the candidate path information may include a source node ID, a destination node ID, the candidate paths 1 to 4, and a path node ID corresponding to each candidate path.

Manner 1-2: The source node determines a primary path from the source node to the destination node based on the statistics information of each hop, allocates a candidate primary path ID to the primary path, where the candidate primary path includes the source node, a plurality of primary relay nodes, and the destination node, and allocates a candidate sub-path ID to a sub-path between nodes forming the candidate primary path. The primary relay node may be a relay node that connects the source node and the destination node, has good channel quality, a small quantity of hops, a strong node capability (for example, supporting full-duplex), a large quantity of antennas, and good power configuration or low power consumption.

As shown in FIG. 8, a determined candidate primary path is {S, R3, R4, R8, D}, an ID of the primary path is 1, there are three candidate sub-paths on the primary path from a source node S to a primary relay node R3, and IDs corresponding to the three candidate sub-paths are 1, 2, and 3, where a candidate sub-path 1 is {S, R1, R3}, a candidate sub-path 2 is {S, R3}, and a candidate sub-path 3 is {S, R2, R3}. Corresponding candidate sub-paths 4 to 6 between a relay node R4 and a relay node R8 may be determined with reference to the sub-paths between the source node S and the relay node R3. In this case, the candidate path information may include a source node ID, a destination node ID, the candidate primary path ID, a path node ID corresponding to the candidate primary path, the candidate sub-path ID, and a path node ID corresponding to the candidate sub-path.

In addition, to limit sub-path indication overheads, the source node may limit a maximum quantity of indicated sub-paths.

In some embodiments, the candidate path information may be indicated by adding bit information to L1 signaling. For example, in the multi-hop multi-link network shown in FIG. 8, the candidate path information determined based on the manner 1-1 includes the candidate paths 1 to 9, and may be indicated by using four bits. For example, 0001 to 1001 indicate the candidate paths 1 to 9. This is applicable to transmission of latency-sensitive aperiodic service data. For another example, in the multi-hop multi-link network shown in FIG. 8, the candidate path information determined based on the manner 1-2 is indicated by using five bits, where one bit indicates a candidate primary path 1, two bits indicate candidate sub-paths 1 to 3, and two bits indicate candidate sub-paths 4 to 6.

The candidate resource information may include the candidate beam set, the candidate control resource set, a candidate data resource set, a candidate modulation and coding scheme (MCS), a resource block (RB) mapping table, and the like. The candidate resource information includes a candidate resource set configured for the node of each hop corresponding to the candidate path information.

The candidate beam set may include a beam set configured for a relay node of each hop in the candidate path information, and may be obtained through centralized configuration based on beam quality information of a large time granularity reported by the relay node of each hop, so that potential inter-hop interference and interference of different paths or adjacent nodes can be avoided cooperatively. The candidate control resource set may include a control resource set configured for the relay node of each hop in the candidate path information, the candidate data resource set may include a data resource set configured for the relay node of each hop in the candidate path information, and the candidate control resource set and the candidate data resource set may include a received and sent time unit, slot resource set, frequency resource set, or the like.

The candidate MCS and RB mapping table may include an MCS and an RB that are configured for the relay node of each hop in the candidate path information, and include the following two configuration manners.

Manner 2-1: A common MCS and/or RB are/is configured. In other words, the same MCS and/or RB are/is configured for the node of each hop. For example, the source node may configure the common MCS and/or RB based on average channel quality or poor channel quality of each hop.

Manner 2-2: A simplified MCS and/or RB are/is configured. For example, an existing defined MCS table and/or RB table are/is reduced to a subset based on average channel quality, or an MCS and/or RB subset are/is limited. For example, the configured MCS and/or RB subset may include {RB configuration 1, MCS configuration 1}, {RB configuration 2, MCS configuration 2}, {RB configuration 3, MCS configuration 3}, and {RB configuration 4, MCS configuration 4}.

The candidate forwarding mode may include a forwarding mode configured for the relay node of each hop in the candidate path information, and the candidate forwarding mode of the relay node of each hop may include one or more of the following: L0 forwarding, L1 forwarding, L2 forwarding, or no forwarding. L0 forwarding corresponds to AF, and L1 forwarding corresponds to DF, SF, and DMF.

It should be noted that the second transmission parameter information may be configured by the source node through lower layer signaling, for example, PHY layer/L1 signaling, or may be configured through higher layer signaling, for example, MAC control element (CE) signaling or RRC signaling. When the second transmission parameter information configured through the higher layer signaling is used, the second transmission parameter information may be activated through the lower layer signaling, for example, L1 activation signaling. In this way, time at which the signaling takes effect can be better controlled.

A specific process in which the source node obtains the second transmission parameter information is applicable to a centralized+distributed scheduling transmission scenario and a centralized scheduling transmission scenario.

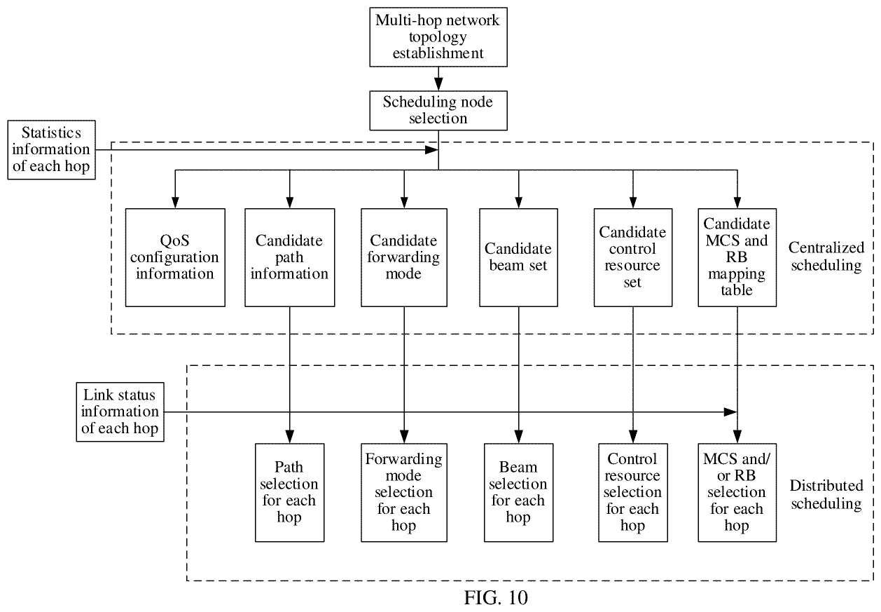

For example, FIG. 10 is a diagram of a structure of implementing multi-hop transmission through centralized+distributed scheduling, and the structure of implementing the multi-hop transmission through the centralized+distributed scheduling is applicable to periodic and aperiodic service transmission. As shown in FIG. 10, the centralized+distributed scheduling is to select, from an established multi-hop network topology, a scheduling node for multi-hop transmission. To be specific, a source node, a destination node, and a plurality of relay nodes are selected for multi-hop transmission, to form a multi-hop transmission network, as shown in the multi-hop multi-link network shown in FIG. 8 or FIG. 9, and then, the centralized scheduling and distributed scheduling are separately performed based on the formed multi-hop transmission network.

As shown in FIG. 10, the centralized scheduling may be a process in which the source node determines the second transmission parameter information based on statistics information of each hop. For a specific implementation process of QoS configuration information, candidate path information, a candidate forwarding mode, and candidate resource information (for example, a candidate beam set, a candidate control resource set, and a candidate MCS and RB mapping table), refer to the foregoing implementation process of the source node. The second transmission parameter information may be obtained through the centralized configuration by the source node shown in FIG. 8 or FIG. 9. The distributed scheduling may be obtained by the node of each hop through dynamical selection from the second transmission parameter information based on obtained link status information of each hop. For a specific process, refer to the following step S702.

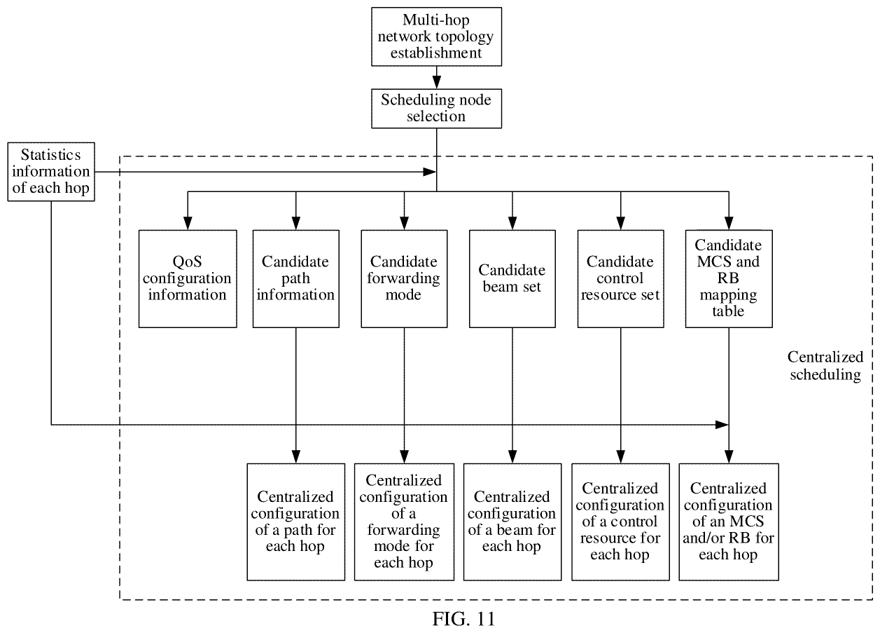

For example, FIG. 11 is a diagram of a structure of implementing multi-hop transmission through centralized scheduling, and is also applicable to periodic and aperiodic service transmission. As shown in FIG. 11, QoS configuration information, candidate path information, a candidate forwarding mode, and candidate resource information (for example, a candidate beam set, a candidate control resource set, and a candidate MCS and RB mapping table) obtained through the centralized scheduling all belong to second transmission parameter information. Alternatively, second transmission parameter information may be determined by the source node based on statistics information of each hop. Alternatively, refer to the implementation process of the source node. In addition, the centralized scheduling shown in FIG. 11 further includes centrally configuring, by the source node, a path of each hop, a forwarding mode of each hop, a beam of each hop, a control resource of each hop, an MCS and/or RB of each hop, and the like based on the statistics information of each hop and the second transmission parameter information. For a specific process, refer to the following step S702.

In some embodiments, the second transmission parameter information may alternatively be determined and sent to the source node by a node (which may also be described as a centralized scheduling node) that has a centralized scheduling capability in the multi-hop transmission network. For example, the centralized scheduling node may be a network device adjacent to the source node in the multi-hop network.

In some embodiments, the first node may alternatively be a relay node. For example, the first node is any relay node (any one of R1 to R8) shown in FIG. 8, and the relay node may be any relay device shown in FIG. 1A, FIG. 1B, or FIG. 2. The first node may receive the second transmission parameter information from a previous-hop node. The previous-hop node may be the source node, or may be the relay node. For example, if the first node is the relay node R3 in FIG. 8, the previous-hop node may be the source node S, or may be the relay node R1 or R2. For determining of the previous-hop node, refer to a determining process of the first node in the following step S702.

In some embodiments, when the first node is the relay node, the first node may receive a cross-carrier indication or a broadcast indication from the source node, where the cross-carrier indication or the broadcast indication carries the second transmission parameter information.

For example, in the multi-hop multi-link network shown in FIG. 8, the source node S may send the second transmission parameter information to the relay node (R1 to R8) of each hop by using low frequency broadcast of a carrier 1, so that the relay node of each hop obtains the second transmission parameter information. A low frequency broadcast indication may cover each relay node. In other words, each relay node may receive the second transmission parameter information from the source node.

In some embodiments, the first node may receive the second transmission parameter information transmitted from the source node to the first node hop by hop. In other words, the first node receives the second transmission parameter information from a previous-hop relay node, where the second transmission parameter information of the previous-hop relay node may be sent from the source node to the relay node hop by hop.

For example, the first node may be the relay node R4 shown in FIG. 8, and the relay node R4 may receive the second transmission parameter information from the previous-hop relay node R3. In other words, the second transmission parameter information of the relay node R4 may be transmitted from the source node S to R4 via the relay node R3. The second transmission parameter information may be carried in the higher layer signaling or the lower layer signaling for sending, and the higher layer signaling or the lower layer signaling may indicate a next-hop relay node to configure transmission parameter information of a next hop.

It may be understood that second transmission parameter information received by a current-hop relay node may be reduced hop by hop. In other words, the second transmission parameter information received by the current-hop relay node may not include second transmission parameter information corresponding to a relay node before the current-hop relay node and second transmission parameter information corresponding to the source node. For example, second transmission parameter information obtained by the relay node R5 in FIG. 8 may not include second transmission parameter information (for example, candidate resource information and a candidate forwarding mode of the nodes R1 to R4) of related nodes such as the relay nodes R1 to R4, and includes only second transmission parameter information of the relay nodes R5 to R8 and the destination node D.

Optionally, the first node may also receive first transmission parameter information from the previous-hop relay node. In this case, the first transmission parameter information obtained by the first node is used by the previous-hop relay node for service data transmission, and may include transmission path information, transmission resource information, a forwarding mode, and the like that are determined by the previous-hop relay node based on the second transmission parameter information. For example, if the first node is the relay node R4 in FIG. 8, and the previous-hop node is the relay node R3 in FIG. 8, the relay node R4 may receive first transmission parameter information from the relay node R3. The first transmission parameter information may also be carried in the lower layer signaling for sending.

S702: The first node determines the first transmission parameter information based on the second transmission parameter information.

In some embodiments, step S702 includes the following step 2-1 and step 2-2, and may be used for implementing the distributed scheduling in FIG. 10.

Step 2-1: The first node obtains one or more pieces of link status information between the first node and one or more next-hop nodes.

The link status information may include one or more of the following: channel quality information, a transmission rate, a transmission latency, or service load information. The link status information may be feedback information sent by the one or more next-hop nodes to the first node.

In some embodiments, the first node may be the source node.

For example, as shown in FIG. 8, the source node S is the first node, and a next-hop node of the source node S may be the relay node R1, R2, or R3, that is, corresponding to three candidate paths. The source node S may send a sounding signal, for example, a channel state information reference signal (CSI-RS) and a sounding reference signal (SRS), to the relay nodes R1, R2, and R3, and each relay node (R1, R2, and R3) may send corresponding link status information to the source node S based on the sounding signal.

In some embodiments, the first node is the relay node.

For example, as shown in FIG. 8, an example in which the relay node R4 is the first node is used. A next-hop node of the relay node R4 may be the relay node R5, R7, or R8, that is, corresponding to three candidate paths for selection. The relay node R4 may also send a sounding signal to the relay node R5, R7, and R8, to receive link status information from the relay node R5, R7, and R8.

Step 2-2: The first node determines the first transmission parameter information based on the link status information and the second transmission parameter information.

The first transmission parameter information is used by the first node for service data transmission, and the first transmission parameter information may include one or more of the following determined by the first node: transmission path information, transmission resource information, or a forwarding mode.

In some embodiments, the first node may be the source node.

For example, in the second transmission parameter information obtained by the source node S shown in FIG. 8, candidate transmission path information of the source node S may include the candidate primary path 1 {S, R3, R4, R8, D}, a candidate sub-path 1 {S, R1, R3}, a candidate sub-path 2 {S, R3}, and a candidate sub-path 3 {S, R2, R3}. The source node S may select a candidate sub-path ID based on link status information corresponding to the relay nodes R1, R2, and R3, to determine a next-hop relay node, namely, the second node. If quality of a channel between the source node S and the relay node R3 is good, the source node S selects the candidate sub-path 2 to forward data, and determines that the next-hop relay node is R3. In this case, the transmission path information may include the candidate primary path 1, the candidate sub-path 2, path node IDs corresponding to the candidate primary path 1 and the candidate sub-path 2, an ID of the next-hop node (relay node R3), and the like.

Alternatively, in the second transmission parameter information obtained by the source node S in FIG. 8, the candidate transmission path information may include the candidate path 1 {S, R1, R3, R4, R5, R6, R8, D}, the candidate path 2 {S, R3, R4, R5, R6, R8, D}, the candidate path 3 {S, R2, R3, R4, R5, R6, R8, D}, the candidate path 4 {S, R1, R3, R4, R8, D}, the candidate path 5 {S, R3, R4, R8. D}, the candidate path 6 {S, R2, R3, R4, R8, D}, the candidate path 7 {S, R1, R3, R4, R7, R8, D}, the candidate path 8 {S, R3, R4, R7, R8, D}, and the candidate path 9 {S, R2, R3, R4, R7, R8, D}. The source node S may also select a candidate path ID based on the link status information. For example, quality of a channel between the source node S and the relay node R3 is good, so that the source node S may select one or more of the candidate paths 2, 5, or 8 as the transmission path information. In this case, the transmission path information may include the candidate path 2, the candidate path 5, the candidate path 8, a path node ID corresponding to each candidate path, an ID of the next-hop node (relay node R3), and the like.

Further, the source node S may determine the forwarding mode based on the transmission latency, the transmission rate, the channel quality information, or the like. If a transmission latency budget is insufficient, AF may be selected as the forwarding mode; or if a transmission latency budget is loose, AF, DF, or SF may be selected as the forwarding mode.

Further, the source node S may determine the transmission resource information based on the link status information. The transmission resource information may include beam configuration, control resource configuration, data resource configuration, and MCS and/or RB configuration. Details are as follows.

(1) Beam configuration: The source node S may select, based on signal quality of each beam in a beam set on a current channel, beam configuration with good signal quality from a candidate beam set corresponding to the source node S.

(2) Control resource configuration: A configured control resource may be used for transmission of the second transmission parameter information and the first transmission parameter information, and the source node S may select an appropriate control resource from a candidate control resource set based on the channel quality information and the like.

(3) Data resource configuration: A configured data resource may be used for forwarding the service data or transmitting local service data, and an appropriate data resource may be selected from a candidate data resource set based on a transmission data size, channel quality information, and the like.

(4) MCS and RB configuration: If a candidate MCS and RB mapping table in the second transmission parameter information is common MCS and RB configuration, the source node S may directly select the common MCS and RB configuration as the MCS and RB configuration. If a candidate MCS and RB mapping table in the second transmission parameter information is simplified MCS and RB configuration, the source node S may select MCS and RB configuration, for example, {RB configuration 1, MCS configuration 1}, from simplified MCS and RB configuration based on channel quality information, a transmission data size, and the like.

Optionally, the first node may also configure an MCS or an RB with reference to the forwarding mode. If the forwarding mode is the DF, either the MCS or the RB may be selected for configuration; or if the forwarding mode is the SF, the RB may be configured, and the MCS does not need to be configured.

In some embodiments, the first node may be the relay node.

For example, as shown in FIG. 8, an example in which the first node is the relay node R4 is used. Candidate transmission path information received by the relay node R4 from the relay node R3 may include a candidate primary path 1 {S, R3, R4, R8, D}, a candidate sub-path 4 {R4, R5, R6, R8}, a candidate sub-path 5 {R4, R8}, and a candidate sub-path 6 {R4, R7, R8}. The relay node R4 may select a candidate sub-path ID based on channel quality information and the like, to determine a next-hop relay node. For example, if quality of a channel between the relay node R4 and the relay node R8 is good, the source node selects the candidate sub-path 5 to forward data, and determines that the next-hop relay node is R8. In this case, the transmission path information may include the candidate primary path 1, a candidate sub-path 2, path node IDs corresponding to the candidate primary path 1 and the candidate sub-path 2, the candidate sub-path 5, a path node ID corresponding to the candidate sub-path 5, an ID of the next-hop node (relay node R8), and the like.

Alternatively, the candidate transmission path information received by the relay node R4 from the relay node R3 in FIG. 8 may include a candidate path 2 {S, R3, R4, R5, R6, R8, D}, a candidate path 5 {S, R3, R4, R8, D}, and a candidate path 9 {S, R2, R3, R4, R7, R8, D}. The relay node R4 may also select a candidate path ID based on channel quality information and the like. For example, quality of a channel between the relay node R4 and the relay node R8 is good, so that the relay node R4 may select the candidate path 5 as the transmission path information. In this case, the transmission path information may include the candidate path 5, a path node ID corresponding to the candidate path 5, an ID of the next-hop node (relay node R8), and the like.

Further, determining, by the relay node R4, a forwarding mode, transmission resource information, and the like is similar to that of the foregoing source node. For details, refer to the implementation process of the foregoing source node.

Optionally, if the first node receives the first transmission parameter information from the previous-hop node, and in this case, the first transmission parameter information is information determined by the previous-hop node, the first node may update the first transmission parameter information based on the link status information and the second transmission parameter information, and updated first transmission parameter information is parameter information used by the first node for service data transmission. In other words, the first transmission parameter information is updated at a node of each hop.

For example, as shown in FIG. 8, the relay node R4 receives first transmission parameter information and candidate path transmission information from the relay node R3, where transmission path information in the first transmission parameter information may include: a candidate primary path 1, a candidate sub-path 2, an ID of each node on the primary path 1 and the sub-path 2, and an ID of a next-hop node (relay node R4). The relay node R4 may update the transmission path information in the first transmission parameter information based on the link status information of the relay node R5, R7, or R8 and a candidate sub-path ID obtained from the second transmission parameter information. For example, updated transmission path information includes: the candidate primary path 1, the candidate sub-path 2, an ID of each node on the candidate primary path 1 and the candidate sub-path 2, the candidate sub-path 5, and the ID of the next-hop node (relay node R8). That is, updated first transmission path information is transmission path information of the relay node R4. An update process of other transmission parameter information is similar to an update process of the transmission path information. It should be noted that, in the transmission resource information configured by the first node, some resources may be used for forwarding the service data, and some resources may be used for transmitting the local service data, to support resource multiplexing of the forwarded service data and the local service data. Alternatively, some resources may be used for L2 forwarding, and/or some resources are used for L1 forwarding, and/or some resources are used for L0 forwarding.

It should be noted that the relay node may configure a transmission resource in the first transmission resource information in a gap of processing and receiving data from the previous-hop node. Specifically, the relay device may support full-duplex or half-duplex communication, and may configure the transmission resource by using the data processing gap between receiving data and sending the data.

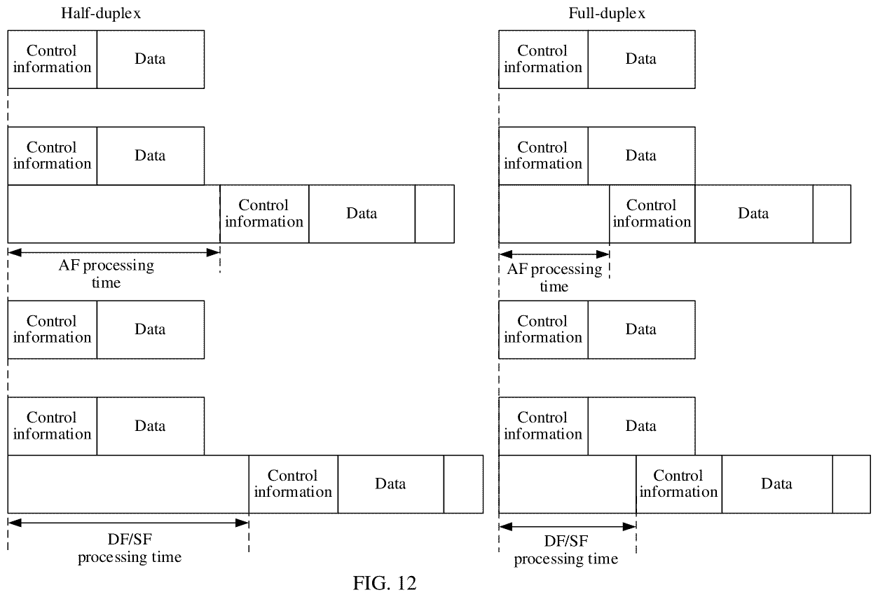

For example, FIG. 12 is a diagram of a structure of data processing performed by a relay node during full-duplex and half-duplex communication. When the relay node supports half-duplex, receiving control or data and sending control or data of the relay node are in time-division. For relay processing, the relay node may first decode a control channel to obtain control information. The control information may indicate one or more of time, a frequency, a beam, and power for subsequently sending data by the relay node. For AF relay forwarding, because received data is amplified and forwarded in an AF operation, the data can be quickly forwarded after being received. It should be noted that processing of receiving control herein may be partially or completely performed when a data channel is received. When a relay is DF or SF forwarding, received data may be decoded or demodulated and forwarded only after a data channel is received. Therefore, forwarding time is after the data channel is received and corresponding receiving time.

When the relay node supports full-duplex, the relay node may receive and send data at the same time. The relay node may forward a part of data after receiving and processing the part of data, for example, after processing each symbol, and still receive another data symbol. Waiting time for AF, DF, or SF processing is shortened, so that the AF, DF, or SF forwarding can be completed quickly. It can be learned that, in comparison with the half-duplex, the full-duplex may have shorter processing time of a relay device, to further improve data transmission efficiency.

In some embodiments, the first node is the source node, and the first transmission parameter information may be obtained through centralized configuration by the source node, and may be used for implementing centralized configuration of a path of each hop, a forwarding mode of each hop, a beam of each hop, a control resource of each hop, an MCS and/or RB of each hop, and the like in centralized scheduling shown in FIG. 11. Specifically, after obtaining the second transmission parameter information, the source node may select, from the second transmission parameter information based on information (that is, statistics information of each hop) reported by each relay node, a candidate path with good average channel quality and small service load, to perform service data transmission. In addition, a transmission resource, a forwarding mode, and the like are centrally configured for the relay node of each hop on the path. To be specific, in this case, the first transmission parameter information includes the determined transmission path information, the transmission resource, the forwarding mode, and the like that are centrally configured for the relay node of each hop on the transmission path, and the first transmission parameter information is transmitted to the relay node of each hop on the path hop by hop along the determined transmission path, and is used by the relay node of each hop to forward the service data.

For example, as shown in FIG. 8, the source node S may select, from the candidate transmission path information in the second transmission parameter information based on average channel quality, average service load, a rate, and the like, a path with good average channel quality and low service load, to perform service data transmission. For example, the path is the candidate path 5 {S, R3, R4, R8, D}.

Then, the source node S configures transmission resource information, a forwarding mode, and the like for each relay node (R3, R4, and R8) on the candidate path 5 based on information reported by the relay node of each hop and the second transmission parameter information.

Specifically, the source node S determines the forwarding mode based on a transmission latency, a transmission rate budget, and the average channel quality. For example, all relay nodes of hops on the path have a same latency and similar channel quality, so that forwarding modes of all relay nodes (R3, R4, and R8) of the hops may be set to be the same, which may be AF or DF, and a quantity of retransmission times may be limited. Alternatively, if latencies of all relay nodes of hops on the path are different, forwarding modes of all relay nodes (R3, R4, and R8) of the hops are different. For example, the forwarding modes are AF/DF/SF respectively.

Further, the source node S may select, from the second transmission parameter information based on the average channel quality, the average service load, the rate, and the like, beam configuration, control resource configuration, data resource configuration, RB configuration, MCS configuration, and the like that correspond to the relay node of each hop, so that the source node obtains the first transmission parameter information that is centrally configured and that includes transmission parameter of the relay node (R3, R4, and R8) of each hop.

S703: The first node sends the service data to the second node based on the first transmission parameter information, and the second node receives the service data from the first node.

The second node is a next-hop node determined by the first node based on the transmission path information.

For example, it is assumed that the first node is the source node S in FIG. 8, and in this case, the first transmission parameter information may be obtained based on the distributed scheduling shown in FIG. 10. The source node S may determine the second node as the relay node R3 based on determined transmission path information. For example, the transmission path information includes a candidate primary path 1 and a candidate sub-path 2, or a candidate path 2, a candidate path 5, or a candidate path 8. With reference to a forwarding mode (for example, SF) and transmission resource information (for example, a beam 1, {RB configuration 1, MCS configuration 1}, and the like), the source node S sends the service data to the relay node R3.

For another example, it is assumed that the first node is the relay node R4 in FIG. 8, and a second node determined by the relay node R4 is the relay node R8, so that the relay node R4 sends the service data to the relay node R8 based on the determined transmission resource information, forwarding mode, and the like.

It may be understood that the service data may be carried on a radio resource and forwarded in a form of a radio frequency signal.

Optionally, the first node may further send the second transmission parameter information and/or the first transmission parameter information to the second node. Correspondingly, the second node receives the second transmission parameter information and/or the first transmission parameter information from the first node.

In some embodiments, the first transmission parameter information may be sent together with the second transmission parameter information.

Specifically, the first transmission parameter information and the second transmission parameter information are carried in same lower layer signaling for sending, for example, L1/PHY layer signaling. Still further, the first transmission parameter information and the second transmission parameter information may be sent before step S703.

In some embodiments, the first transmission parameter information and the second transmission parameter information may be separately sent.

Specifically, before performing step S703, the first node sends the second transmission parameter information to the second node. The second transmission parameter information may be carried in the lower layer signaling for sending, or may be carried in higher layer signaling for sending, for example, MAC CE signaling and RRC signaling. The second transmission parameter information may be sent together with the service data. However, the first transmission parameter information may be sent together with the service data, or may be sent separately from the service data. The first transmission parameter information may be carried in the lower layer signaling.

Optionally, the second transmission parameter information and the first transmission parameter information may be sent by separating a plurality of carriers. For example, the second transmission parameter information may be sent by using a carrier 1, and the first transmission parameter information may be sent by using a carrier 2.

It should be noted that, a process in which the second node forwards the service data is similar to that of the first node, reference may be made to the foregoing steps S701 to S703, and the service data is transmitted to the destination node hop by hop in the foregoing steps S701 to S703 performed by the relay node. For example, in the multi-hop multi-link network shown in FIG. 8, the determined relay node repeatedly performs the foregoing steps S701 to S703, to transmit the service data from the source node S to the destination node D hop by hop. For a specific forwarding process of the relay node of each hop shown in FIG. 8, refer to FIG. 5 and FIG. 6.

In some embodiments, the first node may be the source node shown in FIG. 8, and the first transmission parameter information may be obtained based on the centralized scheduling shown in FIG. 11. In this case, the first transmission parameter information may include a transmission parameter of the relay node (R3, R4, and R8) of each hop, the source node S may carry the first transmission parameter information in the L1 signaling, and transmit the first transmission parameter information to the relay nodes R3, R4, and R8 hop by hop based on the determined transmission path information, for example, the candidate path 5. Each relay node forwards the service data to the destination node D based on the obtained transmission parameter.

It may be understood that, in this case, the first transmission parameter information may also be reduced hop by hop along the transmission path. To be specific, first transmission parameter information obtained by a current-hop relay node may not include transmission parameter information configured for a relay node that has performed transmission before the current-hop relay node. In other words, only transmission parameter information configured by the current-hop relay node and a relay node that performs transmission subsequently may be included. As a result, a transmission resource is saved.

Similarly, parameter configuration and a parameter sending process of the centralized scheduling may also be implemented through the lower layer or higher layer signaling.

It should be noted that, in the multi-hop transmission process implemented through the centralized scheduling shown in FIG. 11, the second transmission parameter information may be sent hop by hop along the determined transmission path, or may not be sent. For a hop-by-hop transmission process of the second transmission parameter information, refer to the foregoing centralized+distributed scheduling process. In addition, a common configuration parameter part (such as a source node ID, a destination node ID, a candidate path ID, and QoS configuration information) of the relay node of each hop in the first transmission parameter information determined through the centralized scheduling may be sent before a specific configuration parameter (such as a control resource of each hop, a forwarding mode of each hop, MCS configuration of each hop, and RB configuration of each hop) of the relay node of each hop is sent.

It may be understood that, for example, in the multi-hop transmission process implemented by the centralized+distributed scheduling shown in FIG. 10 and the centralized scheduling shown in FIG. 11, a plurality of candidate paths may also be selected for transmission, and the plurality of paths may share the service load for sending.

Based on the multi-hop transmission method shown in FIG. 7, the first node may obtain, by obtaining the second transmission parameter information that meets an end-to-end QoS requirement, a candidate transmission parameter set that is of each node in a current multi-hop transmission network and that is centrally configured, and the first node may determine, from the second transmission parameter information, scheduling information used by the first node to forward the service data, namely, the first transmission parameter information. In this way, the first node determines the first transmission parameter information based on the second transmission parameter information, so that a parameter selection range of the first node can be reduced, and signaling overheads can be reduced. In this way, time for the first node to configure the transmission parameter information of a current hop is reduced, and a data transmission latency is reduced. Alternatively, the first node may obtain, from the second transmission parameter information, an optimal transmission parameter through matching for data transmission. This further reduces the data transmission latency, and further improves data transmission efficiency during multi-hop transmission.

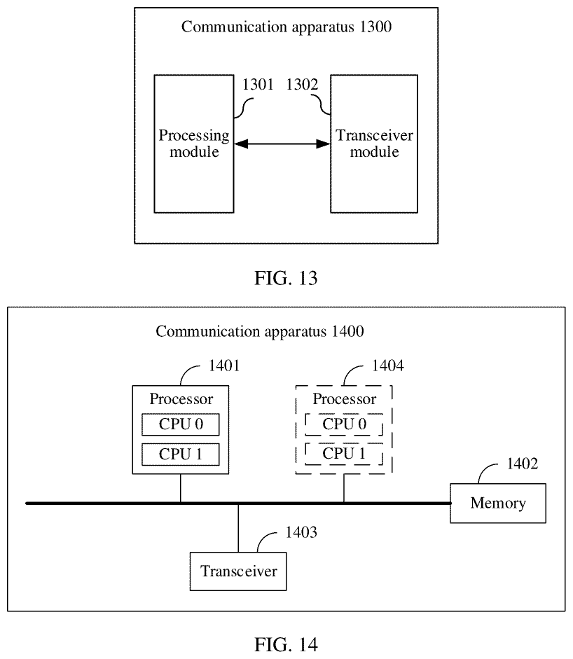

The foregoing describes in detail the multi-hop transmission method provided in embodiments of this disclosure with reference to FIG. 7 to FIG. 12. With reference to FIG. 13 and FIG. 14, the following describes in detail a communication apparatus configured to perform the multi-hop transmission method provided in embodiments of this disclosure.

For example, FIG. 13 is a diagram 1 of a structure of a communication apparatus according to an embodiment of this disclosure. As shown in FIG. 13, the communication apparatus 1300 includes a processing module 1301 and a transceiver module 1302. For ease of description, FIG. 13 merely shows main components of the communication apparatus.

In some embodiments, the communication apparatus 1300 is applicable to the communication system shown in FIG. 1A, FIG. 1B, or FIG. 2, and performs a function of the first node in the multi-hop transmission method shown in FIG. 7. The communication apparatus 1300 may be deployed on the first node.

The processing module 1301 is configured to obtain second transmission parameter information, where the second transmission parameter information includes one or more of the following: quality of service (QoS) configuration information, candidate transmission path information, candidate transmission resource information, or a candidate forwarding mode.

The processing module 1301 is further configured to determine first transmission parameter information based on the second transmission parameter information.

The transceiver module 1302 is configured to send service data to a second node based on the first transmission parameter information, where the second node is a next-hop node determined by the first node based on the first transmission parameter information.

Further, the processing module 1301 is configured to perform the following steps:
obtaining one or more pieces of link status information of the first node and one or more next-hop nodes, where the link status information includes one or more of the following: channel quality information, a transmission rate, a transmission latency, or service load information; and
determining the first transmission parameter information based on the one or more pieces of link status information and the second transmission parameter information.

Further, the first transmission parameter information includes one or more of the following: transmission path information, transmission resource information, or a forwarding mode.

Further, the forwarding mode includes one or more of the following: layer 0 forwarding, layer 1 forwarding, or layer 2 forwarding.

In some embodiments, the transceiver module 1302 is further configured to send the second transmission parameter information and/or the first transmission parameter information to the second node.

In some embodiments, the second transmission parameter information and/or the first transmission parameter information are/is carried in lower layer signaling.

In some embodiments, the transceiver module 1302 is configured to: after sending the second transmission parameter information to the second node, send the first transmission parameter information to the second node.

Further, the second transmission parameter information is carried in higher layer signaling.

In some embodiments, the transceiver module 1302 may include a receiving module and a sending module (not shown in FIG. 13). The sending module is configured to implement a sending function of the communication apparatus 1300, and the receiving module is configured to implement a receiving function of the communication apparatus 1300.

Optionally, the communication apparatus 1300 may further include a storage module (not shown in FIG. 13). The storage module stores a program or instructions. When the processing module 1301 executes the program or the instructions, the communication apparatus 1300 is enabled to perform the function of the first node in the multi-hop transmission method shown in FIG. 7.

It should be understood that the processing module 1301 in the communication apparatus 1300 may be implemented by a processor or a processor-related circuit component, and may be a processor or a processing unit. The transceiver module 1302 may be implemented by a transceiver or a transceiver-related circuit component, and may be a transceiver or a transceiver unit.

It should be noted that the communication apparatus 1300 may be a terminal device, a network device, or a relay device, or may be a chip (system) or another part or component that may be disposed in the terminal device, the network device, or the relay device, or may be an apparatus that includes the terminal device, the network device, or the relay device.

In addition, for technical effects of the communication apparatus 1300, refer to the technical effects of the method shown in FIG. 7.

In some other embodiments, the communication apparatus 1300 is applicable to the communication system shown in FIG. 1A, FIG. 1B, or FIG. 2, and performs a function of the second node in the multi-hop transmission method shown in FIG. 7. The apparatus may be deployed on the second node.

The transceiver module 1302 is configured to send link status information between a first node and the second node to the first node, where the link status information includes one or more of the following: channel quality information, a transmission rate, a transmission latency, or service load information, and the link status information is used by the first node to determine first transmission parameter information.

The transceiver module 1302 is further configured to receive second transmission parameter information and/or the first transmission parameter information from the first node, where the second transmission parameter information includes one or more of the following: quality of service (QoS) configuration information, candidate transmission path information, candidate transmission resource information, or a candidate forwarding mode, the first transmission parameter information indicates the first node to send service data, and the first node is a previous-hop node of the second node.

In some embodiments, the second transmission parameter information and/or the first transmission parameter information are/is carried in lower layer signaling.

In some embodiments, the transceiver module is configured to: after receiving the second transmission parameter information from the first node, receive the first transmission parameter information from the first node.

Further, the second transmission parameter information is carried in higher layer signaling.

Further, the first transmission parameter information includes one or more of the following: transmission path information, transmission resource information, or a forwarding mode.

Further, the forwarding mode includes one or more of the following: layer 0 forwarding, layer 1 forwarding, or layer 2 forwarding.

In some embodiments, the transceiver module 1302 may include a receiving module and a sending module (not shown in FIG. 13). The sending module is configured to implement a sending function of the communication apparatus 1300, and the receiving module is configured to implement a receiving function of the communication apparatus 1300.

In some embodiments, the communication apparatus 1300 may further include a processing module 1301. The processing module 1301 may be configured to implement a processing function of the communication apparatus 1300.

In some embodiments, the communication apparatus 1300 may further include a storage module (not shown in FIG. 13). The storage module stores a program or instructions. When the processing module 1301 executes the program or the instructions, the communication apparatus 1300 is enabled to perform the function of the second node in the multi-hop transmission method shown in FIG. 7.

It should be understood that the processing module 1301 in the communication apparatus 1300 may be implemented by a processor or a processor-related circuit component, and may be a processor or a processing unit. The transceiver module 1302 may be implemented by a transceiver or a transceiver-related circuit component, and may be a transceiver or a transceiver unit.

It should be noted that the communication apparatus 1300 may be the terminal device, the network device, or the relay device shown in FIG. 1A, FIG. 1B, or FIG. 2, or may be a chip (system) or another part or component disposed in the terminal device, the network device, or the relay device, or an apparatus that includes the terminal device, the network device, or the relay device.

In addition, for technical effects of the communication apparatus 1300, refer to the technical effects of the multi-hop transmission method shown in FIG. 7.

For example, FIG. 14 is a diagram 2 of a structure of a communication apparatus according to an embodiment of this disclosure. The communication apparatus may be a terminal device, a network device, or a relay device, or may be a chip (system) or another part or component that may be disposed in the terminal device, the network device, or the relay device. As shown in FIG. 14, the communication apparatus 1400 may include a processor 1401. Optionally, the communication apparatus 1400 may further include a memory 1402 and/or a transceiver 1403. The processor 1401 is coupled to the memory 1402 and the transceiver 1403, for example, may be connected to the memory 1402 and the transceiver 1403 through a communication bus.

The following specifically describes the components of the communication apparatus 1400 with reference to FIG. 14.

The processor 1401 is a control center of the communication apparatus 1400, and may be one processor, or may be a collective name of a plurality of processing elements. For example, the processor 1401 is one or more central processing units (CPUs) or an application-specific integrated circuit (ASIC), or is configured as one or more integrated circuits for implementing embodiments of this disclosure, for example, one or more digital signal processors (DSPs) or one or more field programmable gate arrays (FPGAs).

Optionally, the processor 1401 may perform various functions of the communication apparatus 1400 by running or executing a software program stored in the memory 1402 and invoking data stored in the memory 1402.

In an embodiment, the processor 1401 may include one or more CPUs, for example, a CPU 0 and a CPU 1 shown in FIG. 14.

In an embodiment, the communication apparatus 1400 may include a plurality of processors, for example, the processor 1401 and a processor 1404 shown in FIG. 14. Each of the processors may be a single-CPU processor or may be a multi-CPU processor. The processor herein may be one or more devices, circuits, and/or processing cores configured to process data (for example, computer program instructions).

The memory 1402 is configured to store a software program for executing the solution of this disclosure, and the processor 1401 controls execution of the software program. For a specific implementation, refer to the foregoing method embodiments.

Optionally, the memory 1402 may be a read-only memory (ROM) or another type of static storage device that can store static information and instructions, or a random access memory (RAM) or another type of dynamic storage device that can store information and instructions; or may be an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. However, this is not limited thereto. The memory 1402 may be integrated with the processor 1401, or may exist independently, and is coupled to the processor 1401 through an interface circuit (not shown in FIG. 14) of the communication apparatus 1400.

The transceiver 1403 is configured to communicate with another communication apparatus. For example, the communication apparatus 1400 is a terminal device, and the transceiver 1403 may be configured to communicate with the network device or communicate with another terminal device. For another example, the communication apparatus 1400 is a network device, and the transceiver 1403 may be configured to communicate with a terminal device or communicate with another network device.

Optionally, the transceiver 1403 may include a receiver and a transmitter (not separately shown in FIG. 14). The receiver is configured to implement a receiving function, and the transmitter is configured to implement a sending function.

Optionally, the transceiver 1403 may be integrated with the processor 1401, or may exist independently, and is coupled to the processor 1401 through the interface circuit (not shown in FIG. 14) of the communication apparatus 1400.

It should be noted that the structure of the communication apparatus 1400 shown in FIG. 14 does not constitute a limitation on the communication apparatus. An actual communication apparatus may include more or fewer components than those shown in the figure, combine some components, or have different component arrangement.

In addition, for technical effects of the communication apparatus 1400, refer to the technical effects of the multi-hop transmission method in the foregoing method embodiments.

An embodiment of this disclosure provides a communication system. The communication system includes one or more terminal devices, one or more network devices, and one or more relay devices.

An embodiment of this disclosure provides a computer-readable storage medium, including: The computer-readable storage medium stores computer instructions. When the computer instructions are run on a computer, the computer is enabled to perform the multi-hop transmission method shown in FIG. 7.

An embodiment of this disclosure provides a computer program product including instructions, including a computer program or instructions. When the computer program or the instructions are run on a computer, the computer is enabled to perform the multi-hop transmission method shown in FIG. 7.

The processor in embodiments of this disclosure may be a CPU, or the processor may be another general-purpose processor, an DSP, an ASIC, an FPGA or another programmable logic device, a discrete gate or transistor logic device, a discrete hardware component, or the like. The general-purpose processor may be a microprocessor, or the processor may be any conventional processor or the like.

It may be further understood that the memory in embodiments of this disclosure may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example and not limitation, many forms of random access memories (RAMs) may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented using software, hardware (for example, circuit), firmware, or any combination thereof. When the software is used to implement embodiments, the foregoing embodiments may be implemented completely or partially in a form of a computer program product. The computer program product includes one or more computer instructions or computer programs. When the computer instructions or the computer programs are loaded and executed on a computer, the procedure or functions according to embodiments of this disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and indicates that at least three relationships may exist. For example, A and/or B may indicate the following three cases: Only A exists, both A and B exist, and only B exists. A and B may be singular or plural. In addition, the character “/” in this specification usually indicates an “or” relationship between the associated objects, but may also indicate an “and/or” relationship. For details, refer to the context for understanding.

In this disclosure, “at least one” means one or more, and “a plurality of” means two or more. “At least one of the following items (pieces)” or a similar expression thereof means any combination of these items, including a single item (piece) or any combination of a plurality of items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this disclosure. The execution sequences of the processes should be determined according to functions and internal logic of the processes, and should not be construed as any limitation on the implementation processes of embodiments of this disclosure.

It may be clearly understood by a person skilled in the art that, for the purpose of convenient and brief description, for a detailed working process of the foregoing system, apparatus, and unit, refer to a corresponding process in the foregoing method embodiments.

In the several embodiments provided in this disclosure, it should be understood that the disclosed system, apparatus, and method may be implemented in other manners. For example, the described apparatus embodiment is merely an example. For example, division into the units is merely logical function division and may be other division in other embodiments. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method applicable to a first node, the method comprising:
determining first transmission parameter information, wherein the first transmission parameter information is associated with second transmission parameter information, the second transmission parameter information comprises one or more of: quality of service (QoS) configuration information, candidate transmission path information, candidate transmission resource information, and a candidate forwarding mode; and
sending service data to a second node based on the first transmission parameter information, wherein the second node is a next-hop node associated with the first transmission parameter information.

2. The method according to claim 1, wherein determining the first transmission parameter information comprises:
obtaining one or more pieces of link status information of the first node and one or more next-hop nodes, where in tin, status information comprises one or more of: channel quality information, a transmission rate, a transmission latency, and service load information; and
determining the first transmission parameter information based on the one or more pieces of link status information and the second transmission parameter information.

3. The method according to claim 1, wherein the first transmission parameter information comprises one or more of: transmission path information, transmission resource information, and a forwarding mode.

4. The method according to claim 3, wherein the forwarding mode comprises one or more of: layer 0 forwarding, layer 1 forwarding, and layer 2 forwarding.

5. The method according to claim 1, further comprising:
sending at least one of the second transmission parameter information and the first transmission parameter information to the second node.

6. The method according to claim 5, wherein at least one of the second transmission parameter information and the first transmission parameter information is carried in physical layer signaling.

7. The method according to claim 1, wherein the second transmission parameter information is carried in higher layer signaling.

8. A node, comprising:
a processor; and
a transceiver operatively coupled with the processor, wherein the processor provides execution causing the node to:
send, through the transceiver, link status information, between a first node and the node, to the first node, wherein the link status information comprises one or more of channel quality information, a transmission rate, a transmission latency, and service load information, and the link status information is used to determine first transmission parameter information; and
receive, through the transceiver, second transmission parameter information and/or the first transmission parameter information, from the first node, wherein
the second transmission parameter information comprises one or more of: quality of service (QoS) configuration information, candidate transmission path information, candidate transmission resource information, and a candidate forwarding mode,
the first transmission parameter information indicates the first node to send service data, and
the first node is a previous-hop node of the node.

9. The node according to claim 8, wherein at least one of the second transmission parameter information and the first transmission parameter information is carried in physical layer signaling.

10. The node according to claim 8, wherein the second transmission parameter information is carried in higher layer signaling.

11. The node according to claim 8, wherein the first transmission parameter information comprises one or more of: transmission path information, transmission resource information, and a forwarding mode.

12. The node according to claim 11, wherein the forwarding mode comprises one or more of: layer 0 forwarding, layer 1 forwarding, and layer 2 forwarding.

13. A communication apparatus deployed on a first node, the communication apparatus comprising:
a processor; and
an interface operatively coupled with the processor, wherein the processor is configured to provide execution causing the communication apparatus to:
determine first transmission parameter information based on second transmission parameter information, wherein the second transmission parameter information comprises one or more of: quality of service (QoS) configuration information, candidate transmission path information, candidate transmission resource information, and a candidate forwarding mode; and
send service data to a second node based on the first transmission parameter information, wherein the second node is a next-hop node determined by the first node based on the first transmission parameter information.

14. The communication apparatus according to claim 13, wherein the communication apparatus is further caused to:
obtain one or more pieces of link status information of the communication apparatus and one or more next-hop nodes, wherein the link status information comprises one or more of: channel quality information, a transmission rate, a transmission latency, and service load information; and
determine the first transmission parameter information based on the one or more pieces of link status information and the second transmission parameter information.

15. The communication apparatus according to claim 13, wherein the first transmission parameter information comprises one or more of: transmission path information, transmission resource information, and a forwarding mode.

16. The communication apparatus according to claim 15, wherein the forwarding mode comprises one or more of: layer 0 forwarding, layer 1 forwarding, and layer 2 forwarding.

17. The communication apparatus according to claim 13, wherein the communication apparatus is further caused to:
send the second transmission parameter information and/or the first transmission parameter information to the second node.

18. The communication apparatus according to claim 17, wherein the second transmission parameter information and/or the first transmission parameter information is carried in physical layer signaling.

19. The communication apparatus according to claim 17, wherein the communication apparatus is further caused to:
after sending the second transmission parameter information to the second node, send the first transmission parameter information to the second node.

20. The communication apparatus according to claim 13, wherein the second transmission parameter information is carried in higher layer signaling.
